(19) United States
(12) Patent Application Publication
(10) Pub. No.: US 2009/0012707 A1
(43) Pub. Date: Jan. 8, 2009

(54) Position data entry and route planning entry for portable navigation systems

(76) Inventors: Mark K. Krage, Troy, MI (US); Francis E. Szczublewski, Macomb, MI (US); Siddharth H. D'Silva, Rochester Hills, MI (US); Mark A. Kady, Greentown, IN (US)

Correspondence Address: DELPHI TECHNOLOGIES, INC., M/C 480-410-202, PO BOX 5052, TROY, MI, 48007, US

(21) Appl. No.: 11/825,551

(22) Filed: Jul. 6, 2007

(51) Int. Cl. G01C 21/34; G01C 21/00; G01C 21/26

(52) U.S. Cl. 701/209; 701/200; 701/213

(57) ABSTRACT

A method and system for obtaining positioning data including the steps of providing a navigation device, obtaining positioning data including at least global positioning system (GPS) coordinates, and communicating with a remote database. The method further includes the step of obtaining and storing positioning data from the remote database based upon the GPS coordinates, which includes at least additional addressing information.

### TECHNICAL FIELD

The present invention generally relates to navigation systems, and more particularly, relates to a system and method for obtaining and entering positioning data for navigation systems.

### BACKGROUND OF THE INVENTION

Some vehicles are equipped with navigation systems for instructing or displaying directions to a location. Typically, the navigation systems have a destination entry function and/or points-of-interest databases that can be used to locate known addresses, businesses, or the like. Such navigation systems can also include a map with which the destination can be shown on the display. Navigation systems are generally used by the vehicle's occupants to assist them in finding a particular location.

However, the entry of a destination or a point-of-interest in a navigation device of the navigation system is generally tedious due to the limited amount of communication tools that are installed in the vehicle, and due to the nature of the information being inserted into the navigation device. Typically, identifying a destination or point-of-interest requires the entry of several numerical and alphabetical characters. Thus, due to the potential distraction, it is generally not recommended to type or use other forms of manual entry to enter the destination for points-of-interest while one is driving the vehicle.

Navigation devices can typically save a significant number of destinations, points-of-interest that have been entered into the navigation device, or other data due to the amount of data that can typically be stored in memory devices. As set forth above, it can be tedious to enter in the destination entries or points-of-interest, which can also result in the memory of the navigation device not being used to the full potential. Thus, a user is generally less likely to utilize the available memory of the navigation device to share data or the navigation system entirely due to the time required to enter and save the destination or point-of-interest.

The entry of a waypoint is generally a simplified way of entering the destination or a point-of-interest, which is based upon current global positioning system (GPS) coordinates of the navigation device. Thus, when saving a waypoint as a destination, the current GPS coordinates of the navigation device are saved. However, the user typically needs to enter a name associated with the waypoint and sometimes other additional information in order to identify the location other than the GPS coordinates, which can be a tedious process to enter this information into the navigation system.

Therefore, it is desirable to develop a navigation system with which GPS coordinates or data can be easily tagged and saved using additional address information an saved for later use.

### SUMMARY OF THE INVENTION

According to one aspect of the present invention, a method for obtaining positioning data in a navigation system is provided. The method includes the steps of providing a navigation device, obtaining positioning data including at least global positioning system (GPS) coordinates, and communicating with a remote database. The method further includes the step of obtaining and storing additional positioning data from the remote database based upon the GPS coordinates, and includes at least additional address information.

According to another aspect of the present invention, a navigation system is provided that includes a navigation device, a global positioning system (GPS) device in the navigation device, and a remote database. The navigation device obtains positioning data including at least GPS coordinates. The navigation device communicates with the remote database and obtains additional positioning data based upon said GPS coordinates, which includes at least additional address information.

According to yet another aspect of the present invention, a navigation system is provided that includes a navigation device, an external communication device, and a transferring device. The external communication device obtains positioning data including at least additional address information. The transferring device is in communication between the navigation device and the external communication device. The transferring device transfers the positioning data between the navigation device and the external communication device.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram of a navigation system comprising a GPS device in accordance with one embodiment of the present invention;

FIG. 2 is a block diagram of a navigation system in accordance with another embodiment of the present invention;

FIG. 3 is a block diagram of a navigation system in accordance with yet another embodiment of the present invention; and

FIG. 4 is a flow chart illustrates a method for obtaining positioning data in accordance with an embodiment of the present invention.

### DESCRIPTION OF THE PREFERRED EMBODIMENTS

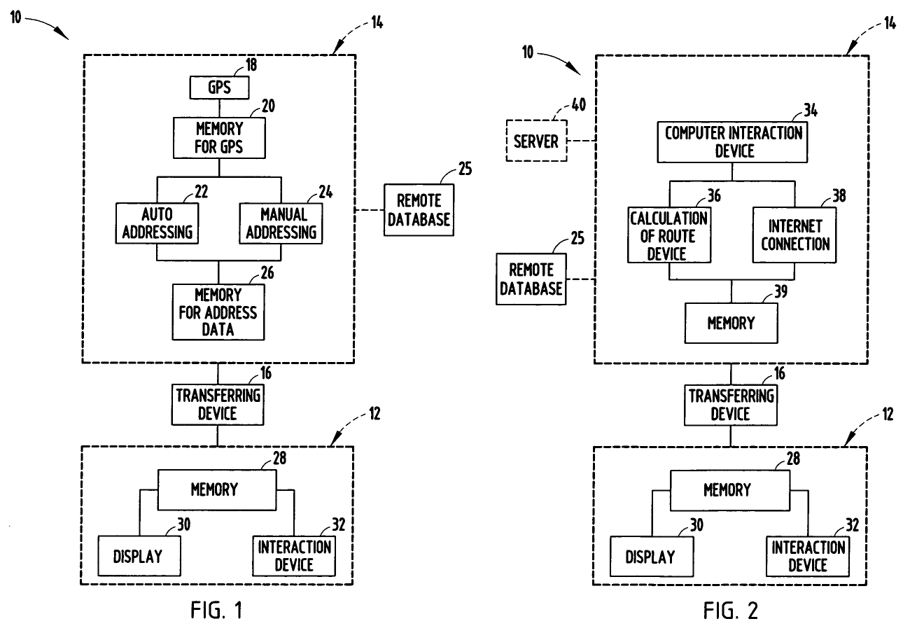

In reference to both FIGS. 1 and 2, a navigation system is generally shown at reference indicator 10. The navigation system 10 comprises a navigation device generally indicated at reference indicator 12 and an external communication device generally indicated at reference indicator 14. As described in greater detail below, FIG. 1 illustrates an embodiment where the external communication device 14 has global positioning system (GPS) capabilities, and FIG. 2 illustrates another embodiment where the external device 14 is an external computer. The external communication device 14 obtains positioning data, which can include at least GPS coordinates and additional address information, as described in greater detail below. The external communication device can then transfer the positioning data to the navigation device 12 by a transferring device 16.

With respect to one embodiment shown in FIG. 1, the external communication device 14 can be a cellular phone with a GPS device 18. Alternatively, the external communication device 14 can be a personal digital assistant (PDA), other portable communication devices, or the like, that has the GPS device 18. The GPS device 18 obtains positioning data, which can include at least GPS coordinates, and saves the GPS coordinates in a memory 20 of the external communication device 14. Typically, the GPS coordinates obtained by the GPS device 18 are in a longitude-latitude format. After the GPS coordinates are obtained, the external communication device 14 obtains additional positioning data which can include at least additional information that is based upon the GPS coordinates, such as, common address information (i.e., street address, zip code, etc.), a business name, or the like, which is typically easier for the user of the navigation system 10 to remember than the longitude-latitude GPS coordinates. Additional address information can be obtained by using an auto addressing device 22 or a manual addressing device 24.

When the auto addressing device 22 is used, the external communication device 14 connects to a remote database 25, such as an address lookup service, a virtual database, or the like, which corresponds the longitude-latitude GPS coordinates to additional address information, such as, but not limited to, common address information, a business name, or the like. Alternatively, the external communication device 14 can obtain additional address information by obtaining a data connection, such as, but not limited to, a text message, an instant message, or the like, which transmits the additional address information based upon the GPS data. Thus, the positioning data can include the GPS coordinates, the additional address information, and other desirable data that is obtained from the remote data base.

The external communication device 14 obtains the data connection or connects to the remote database 25 by a wireless connection. By way of explanation and not limitation, the wireless connection can be a cellular phone connection, a local WiFi connection, a Bluetooth® connection, a satellite connection, or the like. The GPS coordinates can be collected by the GPS device 18 and the wireless connection can be used to connect to the remote database 25 to retrieve additional address information based upon the GPS coordinates. Thus, the GPS coordinates are saved as or associated with common additional address information that was collected by the external communication device 14, which typically allows the user of the navigation system 10 to more easily remember and later recall the information. Further, the positioning data, including the additional address information, is obtained and stored with minimal typing or data entry by the user.

Alternatively, the external communication device 14 does not utilize the GPS device 18 and the auto addressing device can obtain both the GPS coordinates and the additional address information. By way of explanation and not limitation, a user of the navigation system 10 can call a phone number and select an item from a voicemail option, which creates a data connection that transfers the GPS coordinates and/or additional address information. Another example is where a user receives a text message, an instant message, or the like, with GPS coordinates and/or additional address information.

In any of the above describe ways of obtaining the positioning data, if multiple options of additional address information are returned for a location, the user can scroll through a menu to select the desired information. In one embodiment, if the auto addressing device 22 obtains two street addresses or business names for the same GPS coordinates, the user of the navigation system 10 can scroll between the two street addresses or business names and select the street address or business name that the user wants to correspond with the GPS coordinates. It should be appreciated that the above examples can be used in combination with one another or with other suitable forms of data communication. The positioning data, which can include the additional address information, is obtained by the external communication device 14 and stored in a memory for address data 26.

Alternatively, the additional address information can be entered manually using the manual addressing device 24. By way of explanation and not limitation, the manual addressing device 24 can include a display, a keyboard, a key pad, a speech recognition device, the like, or a combination thereof. Thus, the user of the navigation system 10 manually enters the additional address information, such as a street address, business name, or the like, that corresponds to the GPS coordinates. The additional address information is saved in the memory for address data 26. It should be appreciated that the memory for the GPS coordinates 20 and the memory for the address data 26 can be a single memory device that is capable of storing and retrieving both forms of data.

Whether the auto addressing device 22 or manual addressing device 24 is used, the position data can include both the GPS coordinates and the additional address information. Thus, the additional address information is obtained and saved in relation to the GPS coordinates with greater ease than using the limited data entry devices typically associated with the navigation devices.

The external communication device 14 transmits positioning data, which can include the GPS data, the additional address information, or the like, to the navigation device 12 using the transferring device 16. By way of explanation and not limitation, the transferring device 16 is a transmitter and receiver for a wireless communication, a portable memory device, a wire connection between the navigation device 12 and external communication device 14, or the like. The portable memory device can be a universal serial bus (USB) memory stick, a secure digital card, or the like.

The navigation device 12 comprises a memory 28 for storing the positioning data from the external communication device 14 through the transferring device 16. After the positioning data is transferred to the navigation device 12, the navigation device 12 determines a route from a predetermined location to a destination based upon the positioning data. In one embodiment, the predetermined location can be the present location of the navigation device 12. Typically, the navigation device 12 further comprises a display 30 and interactive device 32, with which the user can use to interact with the navigation device 12, view the data the navigation device 12 received from the external communication device 14, or view a map displaying the planned route. By way of explanation and not limitation, interactive device 32 is a virtual keyboard, buttons that are manually pressed, a speech recognition device, the like, or a combination thereof. The navigation device 12 can also instruct the user on how to get from the predetermined location to the destination based upon the positioning data. Thus, an output of the navigation device 12 can be audio output, a visual output, or a combination thereof. Additionally, the user can later easily recall the positioning data on the navigation device 12 because the user can typically remember the more common additional address information rather than the longitude-latitude GPS coordinates.

With respect to another embodiment shown in FIG. 2, the external communication device 14 is an external computer, which comprises a computer interaction device 34, a calculation of route device 36, an Internet connection 38, and memory 39. In addition, the external communication device 14 can be connected to a server 40. Typically, a user enters positioning data into the external communication device 14 by the computer interaction device 34, which can be a keyboard, a virtual keyboard, a key pad, a speech recognition device, the like, or a combination thereof. As set forth above in one embodiment, the positioning data can include the GPS coordinates and/or the additional address information, such as an address (i.e. street address, zip code, etc.), a business name, or the like. The external communication device 14 then calculates a route based upon the positioning data entered into the external communication device 14 and a predetermined location, which can be the present location of the navigation device 12. The calculated route is stored and describes the exact route planned by the external communication device 14, which lists route segments and/or unique destinations in the route in order to store and display on the navigation device 12 the exact route calculated.

In one embodiment, the route is calculated by storing a sufficient amount of destination points or waypoints along the route between the predetermined location and the destination entered into the external communication device 14 without storing route segment data. By saving an adequate amount of route points, if the user of the navigation system 10 goes off the calculated route the navigation device 12 can calculate a route from the off route location to one of the route points rather than re-calculating the entire route from the off route location to the destination. Thus, the navigation device 12 can instruct the user on how to get back on the originally calculated route, and does not have to re-calculate the entire route.

Alternatively, the Internet connection 38 can be used to obtain additional address information as to the location based upon the positioning data entered by the computer interaction device 34. By way of explanation and not limitation, the positioning data can be entered into the remote database 25, such as a web site, with which additional address information as to that location can be displayed and saved from the web site, or the additional address information can be downloaded from the web site onto the external communication device 14. The positioning data, including the additional address information, can then be transferred to the navigation device 12 where the navigation device 12 determines a route based upon the positioning data.

Whether the route based upon the positioning data gathered using the Internet connection 38 is calculated by the navigation device 12 or the external communication device 14, the positioning data is stored on the external communication device 14 in the memory 39. The external communication device 14 transfers the positioning data, including the calculated route if determined by the external communication device 14, to the navigation device 12 using the transferring device 16.

As set forth above, the navigation device 12 comprises the memory 28, the display 30, and interaction device 32. The navigation device 12 receives the data from the external communication device 14. If the external communication device 14 calculated the route, then the navigation device 12 displays the calculated route. However, if the external communication device 14 did not calculate the route, then the navigation device 12 calculates the route based upon the positioning data received from the external communication device 14. The navigation device 12 can output the positioning data as a visual output, an audio output, or a combination thereof.

It should be appreciated that the auto addressing device 22, manual addressing device 24, and the calculation of route device 36 can be any suitable processor. It should further be appreciated that the auto addressing device 22, manual addressing device 24, and the calculation of route device 36 can be separate devices or processors or combined in any predetermined combination of devices or processors.

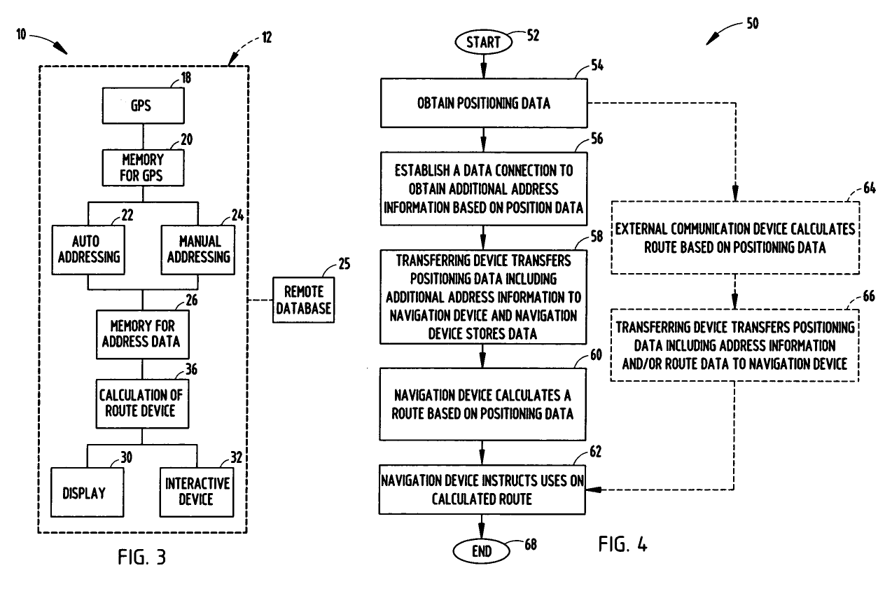

In reference to FIG. 3, another embodiment of the navigation system 10 is shown, where the navigation device 12 obtains the GPS coordinates and the additional address information. The navigation device 12 includes the GPS device 18 and the GPS memory 20 that stores the GPS coordinates obtained by the GPS device 18.

The navigation device 12 also includes the auto addressing device 22 and manual addressing device 24. The auto addressing device 22 connects to the remote database 25, such as the address lookup or virtual database, to retrieve additional address information based upon the GPS coordinates, as described above. Alternatively, the user of the navigation device 12 can use the manual addressing device 24 to obtain and store additional address information based upon the GPS coordinates, as described above.

The positioning data, including the additional address information obtained by the auto addressing device 22 or the manual addressing device 24, is stored in the memory for address data 26. The navigation device 12 then calculates a route from a predetermined location to the destination based upon the positioning data by the calculation of route device 36. The positioning data and the calculated route are displayed on the display 30. Thus, the navigation device 12 can output the positioning data as a visual output, an audio output, or a combination thereof. The user of the navigation device 12 can interact with the navigation device 12 using the interactive device 32.

Thus, the user of the navigation system 10 can obtain the positioning data, including the additional address information, using a single device, such as the navigation device 12. For example, and in no way limiting, if the user of the navigation system 10 is at the desired location, the GPS device 18 can obtain the GPS coordinates of the present position of the navigation device 12. The user can then obtain the additional address information by the auto addressing device 22 or the manual addressing device 24, with which the positioning data, including the additional address information, is then stored in the memory for address data 26. The auto addressing device 22 makes the data connection with the remote database 25 by a wireless connection, as set forth above. Therefore, the user can obtain the GPS coordinates and the additional address information for which the user can typically more easily recall the information by using a single device.

With reference to FIG. 4, a method for obtaining positioning data in a navigation system is generally shown at reference indicator 50. The method 50 starts at step 52 and proceeds to step 54, where the external communication device 14 obtains the positioning data. The positioning data can be GPS coordinates using the GPS device 18 or other positioning data entered by the user. The method 50 then proceeds to step 56, where the external communication device 14 establishes a data connection to obtain address data based upon the positioning data. As set forth above, the data connection can be a phone connection, local WiFi connection, Bluetooth® connection, Internet connection, a satellite connection, or the like. After step 56, the transferring device 16 transfers the positioning data, which can include the address data, to the navigation device 12 and the navigation device 12 stores the data at step 58. The transferring device 16 transfers the positioning data, as set forth above. After that, at step 60, the navigation device 12 calculates a route based upon the positioning data received from the external communication device 14. The method 50 then proceeds to step 62, where the navigation device 12 instructs the user on the calculated route.

Alternatively, after step 54, the method 50 can proceed to step 64, where the external communication device 14 calculates the route based upon the positioning data. After step 64, the method 50 proceeds to step 66, where the transferring device 16 transmits the positioning data, including the address data and/or the route data to the navigation device 12. Next, the method 50 proceeds to step 62, where the navigation device 12 instructs the user on the calculated route. After step 62, the method 50 ends at step 68.

Advantageously, the user can enter positioning data into the navigation system 10 through the external communication device 14 rather than the navigation device 12. By entering the positioning data into the external communication device 14, the user can easily and efficiently include additional address information to the positioning data that corresponds to the positioning data used by the navigation device (i.e. GPS coordinates). Further, with the automatic collection of the location (i.e., GPS coordinates) and the additional address information, the positioning data can be obtained and stored with minimal typing or other data entry by the user. Additionally, the navigation device 12 can be used to obtain the additional address information. Thus, the positioning data is stored in a format that can be more easily recalled by the user than if the positioning data had to be recalled by the user based upon the GPS coordinates. Also, the external communication device 14 can automatically collect and save additional address information that corresponds to the GPS coordinates. Additionally, the external communication device 14 can automatically collect or determine a route from the predetermined location to the destination based upon the positioning data and transfer the route data to the navigation device 12.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A method for obtaining positioning data in a navigation system, said method comprising the steps of:
providing a navigation device;
obtaining positioning data including at least global positioning system (GPS) coordinates;
communicating with a remote database; and
obtaining and storing additional positioning data from said remote database based upon said GPS coordinates, which includes at least additional address information.

2. The method of claim 1, further comprising the step of said navigation device determining a route based upon said predetermined location and said positioning data and outputting said route.

3. The method of claim 1, wherein said steps of communicating with said remote database and obtaining and storing additional positioning data include establishing a data connection with at least one of an address lookup service and virtual database and obtaining additional address information data based upon said positioning data.

4. The method of claim 3, wherein said data connection is a wireless connection.

5. The method of claim 1, wherein said GPS coordinates are saved under a common name on said navigation device based upon said positioning data.

6. The method of claim 1 further comprising the step of providing an external communication device in communication with said navigation device, wherein said external communication device obtains said GPS coordinates and connects to said remote database to obtain said positioning data, and transfers said positioning data to said navigation device.

7. The method of claim 6, wherein said external communication device has a global positioning system (GPS) device.

8. The method of claim 6, wherein said external communication device is an external computer.

9. The method of claim 6, further comprising the step of said external communication device determining route data based upon the present location of said navigation device and said positioning data.

10. The method of claim 9, further comprising the step of transferring at least one of said positioning data and said route data to said navigation device by at least one of a wireless connection and a portable memory device.

11. A navigation system comprising:
a navigation device;
a global positioning system (GPS) device in said navigation device, wherein said navigation device obtains positioning data including at least GPS coordinates; and
a remote database, wherein said navigation device communicates with said remote database and obtains additional positioning data based upon said GPS coordinates, which includes at least additional address information.

12. The navigation system of claim 11 further comprising an external communication device having a global positioning system (GPS) device and in communication with said navigation device and said remote database, wherein said external communication device obtains positioning data including at least said GPS coordinates and said additional address information from said remote database.

13. The navigation system of claim 12 further comprising a transferring device in communication with said navigation device and said external communication device, wherein said transferring device transfers said positioning data between said navigation device and said external communication device.

14. The navigation system of claim 11, wherein said navigation device saves said positioning data as a common name.

15. The navigation system of claim 11, wherein said navigation device determines a route from a present location of said navigation device to a destination based upon said positioning data.

16. A navigation system comprising:
a navigation device;
an external communication device, wherein said external communication device obtains positioning data including at least additional address information; and
a transferring device in communication between said navigation device and said external communication device, wherein said transferring device transfers said positioning data between said navigation device and said external communication device.

17. The navigation system of claim 16, wherein said external communication device includes a global positioning system (GPS) device.

18. The navigation system of claim 16, wherein said transferring device is at least one of a wireless transmitter and receiver and a portable memory device.

19. The navigation system of claim 16 further comprising a remote database, wherein said external communication device establishes a data connection with said remote database and obtains said additional address information based upon said positioning data and transfers results to said navigation device.

20. The navigation system of claim 16, wherein one of said navigation device and said external communication device determine a route from a predetermined location to a destination based upon said positioning data.
